(19) United States
(12) Patent Application Publication
(10) Pub. No.: US 2025/0244597 A1
(43) Pub. Date: Jul. 31, 2025

(54) TESTER, SYSTEM, AND METHOD FOR TESTING AN OPTICAL SENSOR

(71) Applicant: Rohde & Schwarz GmbH & Co. KG, Munich (DE)

(72) Inventors: Moritz UEFFING, Munich (DE); Benedikt SIMPER, Buch am Erlbach (DE); Maximilian FINK, Munich (DE)

(73) Assignee: Rohde & Schwarz GmbH & Co. KG, Munich (DE)

(21) Appl. No.: 18/423,453

(22) Filed: Jan. 26, 2024

(51) Int. Cl. G02B 27/28; G02B 26/04

(52) U.S. Cl. CPC G02B 27/283; G02B 26/04

(57) ABSTRACT

A tester for testing an optical sensor is provided. Said tester comprises an optical input configured to receive an optical signal from the optical sensor, an optical modification unit configured to optically modify and/or delay the optical signal to form a modified and/or delayed optical signal, and an optical output configured to transmit the modified and/or delayed optical signal to the optical sensor. In this context, the optical signal is modified and/or delayed according to a certain number of times to form the modified and/or delayed optical signal.

### TECHNICAL FIELD

The disclosure relates to testing an optical sensor such as a light detection and ranging, LiDAR, sensor, a light imaging, detection and ranging, LIDAR, sensor, or a light amplification by stimulated emission of radiation detection and ranging, LADAR, sensor. In particular, the disclosure relates to a tester for testing an optical sensor, a system for testing an optical sensor, which comprises such a tester, and a method for testing an optical sensor.

### BACKGROUND ART

Generally, in times of an increasing number of applications employing optical sensors, such as autonomous driving applications exemplarily employing LiDAR sensors or the like, there is a growing need of a tester for testing an optical sensor, a system for testing an optical sensor, and a method for testing an optical sensor to verify correct functioning of such applications or optical sensors, respectively, in a highly accurate and efficient manner.

U.S. Pat. No. 8,228,228 B2 discloses apparatus and method for receiving electromagnetic waves using photonics including a transmission unit transmitting electromagnetic waves in intervals; a time delay unit coupled to the transmission unit and controlling the transmission unit to transmit the electromagnetic waves in the intervals; an antenna receiving the electromagnetic waves reflected from the target; an interferoceiver coupled to the antenna and receiving the electromagnetic waves from the antenna, the interferoceiver comprising an optical recirculation loop to produce replica electromagnetic waves; and a computer identifying the target from the reflected electromagnetic waves.

Disadvantageously, said apparatus and method do not allow for testing optical sensors in a highly accurate and efficient manner.

### SUMMARY

Thus, there is a need to provide a tester for testing an optical sensor, a system for testing an optical sensor, and a method for testing an optical sensor to perform measurements or tests, respectively, in a highly accurate and efficient manner.

This is achieved by the embodiments provided in the enclosed independent claims. Advantageous implementations of the present disclosure are further defined in the dependent claims.

According to a first aspect of the present disclosure, a tester for testing an optical sensor is provided. Said tester comprises an optical input configured to receive an optical signal from the optical sensor, an optical modification unit configured to optically modify and/or delay the optical signal to form a modified and/or delayed optical signal, and an optical output configured to transmit the modified and/or delayed optical signal to the optical sensor. In this context, the optical signal is modified and/or delayed according to a certain number of times to form the modified and/or delayed optical signal. Advantageously, the optical sensor can be tested in a particularly accurate and efficient manner. Further advantageously, the certain number of times may especially refer to a number of loops being preferably equivalent to the correspondingly desired delay.

According to an implementation form of the first aspect of the present disclosure, the optical signal is modified and/or delayed in an exclusively optical manner to form the modified and/or delayed optical signal. Advantageously, for instance, both accuracy and efficiency can further be increased. Further advantageously, electronic sampling and recreation of the optical signal with light or laser sources can be rendered irrelevant.

According to a further implementation form of the first aspect of the present disclosure, the optical signal is modified and/or delayed in a repeatable or repeated manner to form the modified and/or delayed optical signal. Advantageously, for example, a variable delay and/or a variable return pulse energy can be achieved in a simple, and thus particularly cost- and size-efficient, manner.

According to a further implementation form of the first aspect of the present disclosure, the optical input comprises an optical path selector switch especially for selection between an input path, preferably for inputting the optical signal, and a modification path, preferably coming from and/or leading to the optical modification unit. Advantageously, for instance, complexity can be reduced, thereby increasing efficiency.

According to a further implementation form of the first aspect of the present disclosure, the optical path selector switch comprises or is an optical polarizing element and/or an optical polarizing beam splitter and/or a chopper wheel, especially an optical chopper wheel, and/or an optical and/or mechanical switch and/or an electro-optical switch and/or a micro-electromechanical system (MEMS). Advantageously, for example, inefficiencies can further be reduced. Further advantageously, the optical polarizing beam splitter can comprise or be an optical polarizing beam splitter in combination with a polarization changing element.

According to a further implementation form of the first aspect of the present disclosure, the optical output comprises an optical path selector switch especially for selection between an output path, preferably for outputting the modified and/or delayed optical signal, and a modification path, preferably coming from and/or leading to the optical modification unit. Advantageously, for instance, simplicity can be increased, which leads to reduced inefficiencies.

According to a further implementation form of the first aspect of the present disclosure, the optical path selector switch comprises or is an optical polarizing element and/or an optical polarizing beam splitter and/or a chopper wheel, especially an optical chopper wheel, and/or an optical and/or mechanical switch and/or an electro-optical switch and/or a micro-electromechanical system (MEMS). Advantageously, for example, efficiency can further be increased.

According to a further implementation form of the first aspect of the present disclosure, the optical input and the optical output are configured as a combined optical input-output. Advantageously, for instance, costs can be reduced by reducing the bill of materials.

According to a further implementation form of the first aspect of the present disclosure, the combined optical input-output comprises an optical path selector switch especially for selection between an input path, preferably for inputting the optical signal, an output path, preferably for outputting the modified and/or delayed optical signal, and a modification path, preferably coming from and/or leading to the optical modification unit. Advantageously, for example, complexity can be reduced, thereby increasing efficiency.

According to a further implementation form of the first aspect of the present disclosure, the optical path selector switch comprises or is an optical polarizing element and/or an optical polarizing beam splitter and/or a chopper wheel, especially an optical chopper wheel, and/or an optical and/or mechanical switch and/or an electro-optical switch and/or a micro-electromechanical system (MEMS). Advantageously, for instance, inefficiencies can further be reduced.

According to a further implementation form of the first aspect of the present disclosure, the tester further comprises an optical switch, wherein the optical switch is configured to pass the modified and/or delayed optical signal to the optical output after the optical signal has been modified and/or delayed according to the certain number of times. Advantageously, for example, especially exclusively for the case that the certain number of times is achieved, the modified and/or delayed optical signal can reliably and efficiently be released to the optical sensor. Further advantageously, especially exclusively for the case that the certain number of times is not achieved yet, the optical signal remains trapped in a corresponding modification and/or delay loop in a particularly reliable manner.

According to a further implementation form of the first aspect of the present disclosure, the optical switch comprises or is an electro-optic switch and/or a Pockels cell and/or an acousto-optic modulator. In addition to this or as an alternative, the tester and/or the optical switch further comprises a polarizer and/or a polarization retarder and/or a half-wave plate and/or a quarter-wave plate and/or an eighth-wave plate, especially wherein the polarizer and/or the polarization retarder and/or the half-wave plate and/or the quarter-wave plate and/or the eighth-wave plate is coupled to and/or part of the optical switch. Advantageously, for instance, complexity can further be reduced, which leads to an increased efficiency.

According to a further implementation form of the first aspect of the present disclosure, the optical modification unit comprises a circular structure. Alternatively, the optical modification unit comprises a linear structure especially comprising at least one optically reflective element, preferably at least two optically reflective elements or two optically reflective elements. Advantageously, for example, flexibility can be increased, thereby reducing inefficiencies.

According to a further implementation form of the first aspect of the present disclosure, the optical modification unit comprises at least one optical delay line, and/or at least one switched optical delay line. Advantageously, for instance, a desired time delay with respect to the optical signal can be adjusted in a particularly flexible, and thus also efficient, manner.

According to a further implementation form of the first aspect of the present disclosure, the tester and/or the optical modification unit comprises at least one optical amplifier, and/or at least one optical attenuator. Advantageously, for example, the correspondingly returned pulse energy can be adjusted efficiently.

According to a further implementation form of the first aspect of the present disclosure, the tester and/or the optical modification unit comprises an optical modulator configured to add a Doppler shift with respect to the optical signal and/or the modified and/or delayed optical signal. Advantageously, for instance, accuracy and efficiency can further be increased. Further advantageously, frequency-modulated-continuous-wave (FMCW) LiDAR systems can be addressed.

According to a second aspect of the present disclosure, a system for testing an optical sensor is provided. Said system comprises a tester according to the first aspect of the present disclosure or any of its implementation forms, respectively, and a controller. In this context, the controller is configured to control the tester especially in accordance with an optical sensor test scenario. Additionally or alternatively, the controller is configured to set the certain number of times especially in accordance with an optical sensor test scenario. Advantageously, the optical sensor can be tested in a particularly accurate and efficient manner. Further advantageously, the controller can be configured to select at least one optical pulse from the optical sensor or the corresponding LiDAR system, respectively.

According to an implementation form of the second aspect of the present disclosure, the controller is configured to take into account the corresponding frame rate of the optical sensor especially in the context of controlling the tester and/or setting the certain number of times. Advantageously, for instance, preferably based on said frame rate, switching, especially slow switching, can be used to adjust a corresponding delay, which leads to an increased efficiency. Further advantageously, the controller can be configured to control the corresponding amplification and/or attenuation based on the frame rate.

According to a further implementation form of the second aspect of the present disclosure, the system further comprises the optical sensor, wherein the optical sensor comprises or is a light detection and ranging, LiDAR, sensor, and/or a light imaging, detection and ranging, LIDAR, sensor and/or a light amplification by stimulated emission of radiation detection and ranging, LADAR, sensor. Advantageously, for example, autonomous vehicles, especially autonomous cars, and/or an advanced driver assistance systems (ADAS) can be tested in a particularly accurate and efficient manner.

According to a third aspect of the present disclosure, a method for testing an optical sensor is provided. Said method comprises the steps of receiving an optical signal from the optical sensor especially with the aid of an optical input of a tester, optically modifying and/or delaying the optical signal to form a modified and/or delayed optical signal especially with the aid of an optical modification unit of the tester, and transmitting the modified and/or delayed optical signal to the optical sensor especially with the aid of an optical output of the tester. In this context, the optical signal is modified and/or delayed according to a certain number of times to form the modified and/or delayed optical signal. Advantageously, the optical sensor can be tested in a particularly accurate and efficient manner. Further advantageously, the certain number of times may especially refer to a number of loops being preferably equivalent to the correspondingly desired delay.

### BRIEF DESCRIPTION OF THE DRAWINGS

The above-described aspects and implementation forms of the present disclosure will be explained in the following description of specific embodiments in relation to the enclosed drawings, in which:

FIG. 1 shows an exemplary embodiment of the first aspect of the disclosure;

FIG. 2 shows a further exemplary embodiment of the first aspect of the disclosure;

FIG. 3 shows a further exemplary embodiment of the first aspect of the disclosure;

FIG. 4 shows an exemplary embodiment of the second aspect of the disclosure based on the exemplary embodiment according to FIG. 1; and

FIG. 5 shows a flow chart of an exemplary embodiment of the third aspect of the disclosure.

### DETAILED DESCRIPTIONS OF EMBODIMENTS

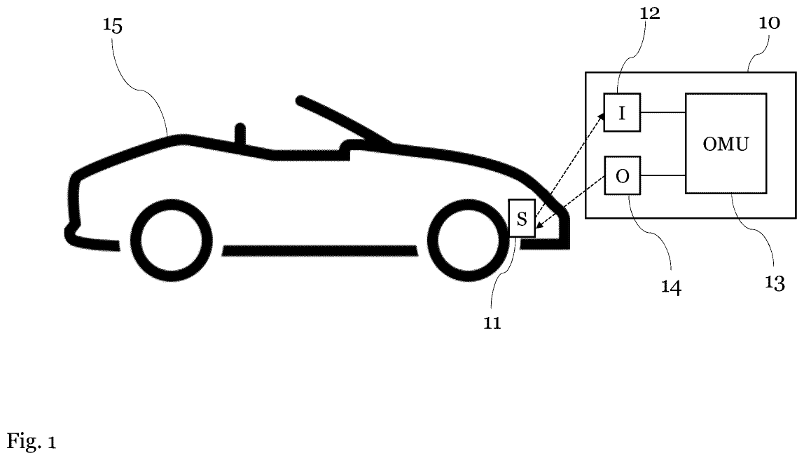

With respect to FIG. 1, an exemplary embodiment of a tester 10 for testing an optical sensor 11 is depicted. Said tester 10 comprises an optical input 12 configured to receive an optical signal from the optical sensor 11, an optical modification unit 13 configured to optically modify and/or delay the optical signal to form a modified and/or delayed optical signal, and an optical output 14 configured to transmit the modified and/or delayed optical signal to the optical sensor 11. In this context, the optical signal is modified and/or delayed according to a certain number of times to form the modified and/or delayed optical signal.

It is noted that it might be particularly advantageous if the optical signal is modified and/or delayed in an exclusively optical manner to form the modified and/or delayed optical signal. It is further noted that the optical signal may especially be modified and/or delayed in a repeatable or repeated manner to form the modified and/or delayed optical signal. It might be particularly advantageous if the optical signal is trapped in a loop, especially for the certain number of times, to form the modified and/or delayed optical signal. Accordingly, the tester 10 and/or the optical modification unit 13 may be configured to trap the optical signal in a loop, preferably in an optical loop, more preferably in an exclusively optical loop, especially for the certain number of times, to form the modified and/or delayed optical signal. With respect to said loop or optical loop, respectively, it is noted that the loop or optical loop, respectively, can comprise or be an optical displacement path, a fiber loop, an optical resonator, a free space optical resonator, a multipass cell, a herriott cell, a white cell, or any combination thereof.

As it can further be seen from FIG. 1, in this exemplary case, a vehicle, exemplarily a car 15, comprises the optical sensor 11. Accordingly, the tester 10 is exemplarily used in the context of testing an autonomous vehicle, especially an autonomous car, and/or an advanced driver assistance system (ADAS).

With respect to the optical sensor 11, it is noted that said optical sensor 11 can comprise or be a light detection and ranging, LiDAR, sensor, and/or a light imaging, detection and ranging, LIDAR, sensor and/or a light amplification by stimulated emission of radiation detection and ranging, LADAR, sensor.

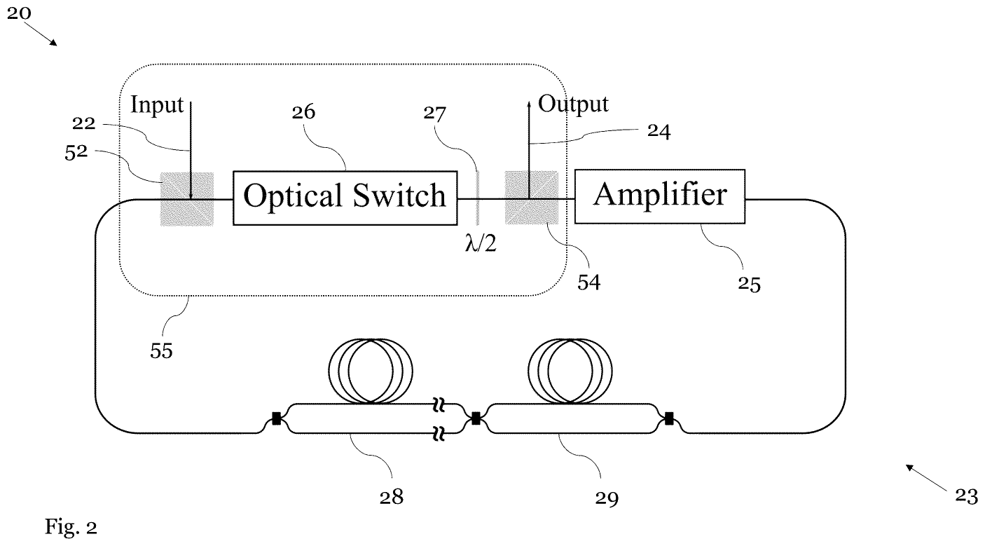

Now, with respect to FIG. 2, a further exemplary embodiment of a tester 20 is illustrated. Said tester 20 comprises an optical input 22, which is exemplarily implemented with the aid of a first polarizer 52, an optical switch 26, a polarization retarder, exemplarily a half-wave plate 27, an optical output 24, which is exemplarily implemented with the aid of a second polarizer 54, an optical amplifier 25, a first optical delay line 28, and a second optical delay line 29. In this context, it is noted that the tester 20 comprises an optical modification unit 23 comprising said optical amplifier 25, said first optical delay line 28, and said second optical delay line 29. It is noted that said optical amplifier 25 can be optional. It is further noted that said two optical delay lines 28 and 29 can be replaced by one or more optical delay lines. Each or at least one or one of such delay lines or of the delay lines 28 and 29 may comprise a length of between 1 meter to 1500 meters, preferably between 10 meters and 1200 meters, more preferably between 50 meters and 800 meters, most preferably between 100 meters and 500 meters.

It is further noted that the optical modification unit 23 exemplarily comprises a circular structure. In particular, in this exemplary case, the tester 20, especially as a whole, comprises a circular structure. Accordingly, the optical input 22 or the first polarizer 52, respectively, is connected to the optical switch 26 and a series connection of the first optical delay line 28 and the second optical delay line 29, wherein the optical switch 26 is connected to the optical output 24 or the second polarizer 54, respectively, via the polarization retarder, exemplarily the half-wave plate 27. Furthermore, the optical output 24 is connected to the series connection of the first optical delay line 28 and the second optical delay line 29 via the optical amplifier 25. As indicated by reference sign 55, it might be particularly advantageous if the optical switch 26 comprises or encapsulates the first polarizer 52 and/or the second polarizer 54 and/or the polarization retarder, exemplarily the half-wave plate 27.

The optical input 22 is configured to receive an optical signal from an optical sensor, such as the above-mentioned optical sensor 11 of FIG. 1. Furthermore, the optical modification unit 23 is configured to optically modify and/or delay the optical signal to form a modified and/or delayed optical signal. Moreover, the optical output 24 is configured to transmit the modified and/or delayed optical signal to the optical sensor. In this context, the optical signal is modified and/or delayed according to a certain number of times to form the modified and/or delayed optical signal.

It is noted that in this exemplary case, the optical signal is modified and/or delayed in an exclusively optical manner to form the modified and/or delayed optical signal. It is further noted that the optical signal may especially be modified and/or delayed in a repeatable or repeated manner to form the modified and/or delayed optical signal. It might be particularly advantageous if the optical signal is trapped in a loop, especially for the certain number of times, to form the modified and/or delayed optical signal. Accordingly, the tester 20 and/or the optical modification unit 23 may be configured to trap the optical signal in an exclusively optical loop, especially for the certain number of times, to form the modified and/or delayed optical signal. With respect to said loop or optical loop, respectively, it is noted that the loop or optical loop, respectively, can comprise or be an optical displacement path, a fiber loop, an optical resonator, a free space optical resonator, a multipass cell, a herriott cell, a white cell, or any combination thereof.

With respect to the above-mentioned optical input 22, it is noted that it might be particularly advantageous if the optical input 22 comprises an optical path selector switch especially for selection between an input path, preferably for inputting the optical signal, and a modification path, preferably coming from and/or leading to the optical modification unit. It is noted that this can analogously apply for the optical input 12 of FIG. 1. It is further noted that in this exemplary case according to FIG. 2, said modification path is connected to the optical switch 26 at one end, and to the series connection of the first optical delay line 28 and the second optical delay line 29 at the other end.

With respect to the above-mentioned optical path selector, it is noted that it might be particularly advantageous if the optical path selector switch comprises or is an optical polarizing element and/or an optical polarizing beam splitter and/or a chopper wheel, especially an optical chopper wheel, and/or an optical and/or mechanical switch and/or an electro-optical switch and/or a micro-electromechanical system (MEMS).

With respect to the above-mentioned optical output 24, it is noted that it might be particularly advantageous if the optical output 24 comprises an optical path selector switch especially for selection between an output path, preferably for outputting the modified optical signal, and a modification path, preferably coming from and/or leading to the optical modification unit. It is noted that this can analogously apply for the above-mentioned optical output 14 according to FIG. 1. It is further noted that in this exemplary case according to FIG. 2, said modification path is connected to the polarization retarder, exemplarily the half-wave plate 27, at one end, and to the optical amplifier 25 at the other end.

With respect to the above-mentioned optical path selector, it is noted that it might be particularly advantageous if the optical path selector switch comprises or is an optical polarizing element and/or an optical polarizing beam splitter and/or a chopper wheel, especially an optical chopper wheel, and/or an optical and/or mechanical switch and/or an electro-optical switch and/or a micro-electromechanical system (MEMS).

Furthermore, with respect to the above-mentioned optical switch 26, it is noted that said optical switch is exemplarily configured to pass the modified optical signal to the optical output after the optical signal has been modified according to the certain number of times. Accordingly, it might be particularly advantageous if the optical switch 26 is configured to release the optical signal trapped in the loop, exemplarily the exclusively optical loop, especially after the certain number of times, to the optical sensor.

Moreover, it is noted that it might be particularly advantageous if the optical switch 26 comprises or is a Pockels cell and/or an acousto-optic modulator.

It is further noted that in addition to or as an alternative to the above-mentioned (optional) optical amplifier 25, at least one optical attenuator or any combination of optical amplifiers and attenuators can be used.

With respect to the first optical delay line 28, it is noted that it might be particularly advantageous if the first optical delay line comprises or is a switched optical delay line. Exemplarily, the first optical delay line 28 comprises or is variable optical delay line, preferably a variable optical delay line with switches, more preferably a variable optical delay line with slow switches. It is noted that the first optical delay line 28 can also comprise or be other optical delays that can be slowly modified.

Furthermore, with respect to the second optical delay line 29, it is noted that it might be particularly advantageous if the second optical delay line 29 comprises or is a fixed optical delay line. Exemplarily, the second optical delay line 29 comprises or is an optical fiber and/or free space.

Moreover, with respect to the above-mentioned series connection of the first optical delay line 28 and the second optical delay line 29, it is noted that said series connection can especially be a single optical delay line of the type of the first optical delay line 28 or of the type of the second optical delay line 29, or any combination of such optical delay lines. It is further noted that, as indicated above, said series connection can also comprise or be multiple optical delay lines of the type of the first optical delay line 28 and/or of the type of the second optical delay line 29, or any combination of such optical delay lines. The first optical delay line 28 and/or the second optical delay line 29 may comprise at least one of an optical displacement path, a fiber loop, an optical resonator, a free space optical resonator, a multipass cell, a herriott cell, a white cell, or any combination thereof. Furthermore, the first optical delay line 28 and/or the second optical delay line 29 might be selectable. Moreover, there can be one or multiple states selecting one or multiple delay lines.

It is further noted that it might be particularly advantageous if the tester 20 and/or the optical modification unit 23 comprises an optical modulator configured to add a Doppler shift with respect to the optical signal and/or the modified optical signal. In this context, it might be particularly advantageous if said optical modulator is arranged such that the optical modulator is not part of the above-mentioned loop, exemplarily the exclusively optical loop. This can analogously apply for the above-mentioned tester 10 and/or the optical modification unit 13 of FIG. 1 and for the tester 30 and/or the optical modification unit 33 as described in the following.

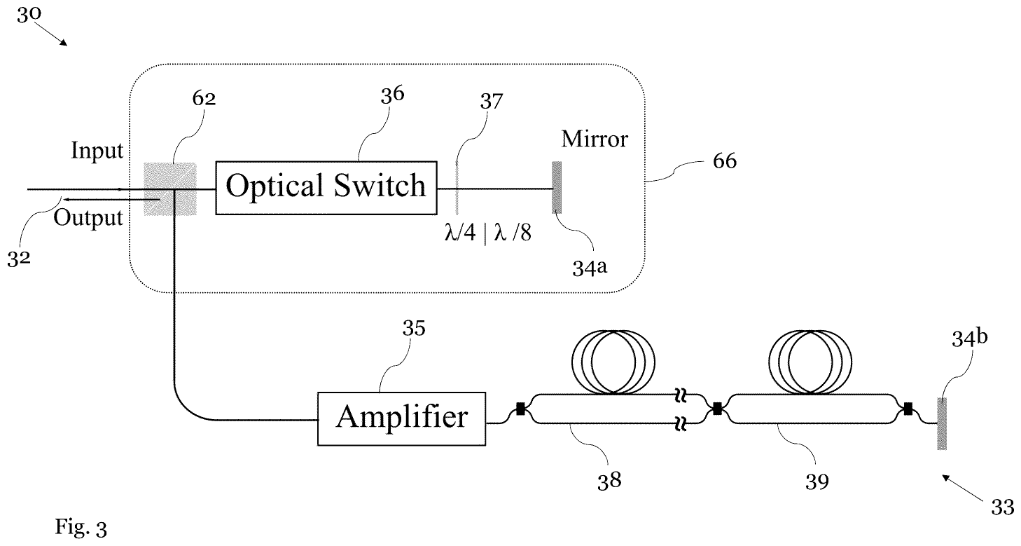

As indicated before, FIG. 3 shows a further exemplary embodiment of a tester 30. Said tester 30 comprises a combined optical input-output 32, which is exemplarily implemented with the aid of a polarizer 62, an optical switch 36, a polarization retarder, exemplarily a quarter-wave plate or an eighth-wave plate 37, a first optically reflective element, exemplarily a first mirror 34a, a second optically reflective element, exemplarily a second mirror 34b, an optical amplifier 35, a first optical delay line 38, and a second optical delay line 39. In this context, it is noted that the tester 30 comprises an optical modification unit 33 comprising the optical amplifier 35, the first optical delay line 38, the second optical delay line 39, the first optically reflective element, exemplarily the first mirror 34a, and the second optically reflective element, exemplarily the second mirror 34b. It is noted that said optical amplifier 35 can be optional. It is further noted that two optical delay lines 38 and 39 can be replaced by one or more optical delay lines.

It is further noted that the optical modification unit 33 exemplarily comprises a linear structure. In particular, in this exemplary case, the tester 30, especially as a whole, comprises a linear structure. Accordingly, the combined optical input-output 32 or the polarizer 62, respectively, is connected to the optical switch 36 and to the optical amplifier 35. The optical switch 36 is connected to the first optically reflective element, exemplarily the first mirror 34a, via the polarization retarder, exemplarily the quarter-wave plate or the eighth-wave plate 37. The optical amplifier 35 is connected to the second optically reflective element, exemplarily the second mirror 34b, via a series connection of the first optical delay line 38 and the second optical delay line 39. As indicated by reference sign 66, it might be particularly advantageous if the optical switch 36 comprises or encapsulates the polarizer 62 and/or the polarization retarder, exemplarily the quarter-wave plate or the eight-wave plate 37, and/or the first optically reflective element, exemplarily the first mirror 34a.

The combined optical input-output 32, especially an input portion thereof, is configured to receive an optical signal from an optical sensor, such as the above-mentioned optical sensor 11 of FIG. 1. Furthermore, the optical modification unit 33 is configured to optically modify and/or delay the optical signal to form a modified and/or delayed optical signal. Moreover, the combined optical input-output 32, especially an output portion thereof, is configured to transmit the modified and/or delayed optical signal to the optical sensor. In this context, the optical signal is modified and/or delayed according to a certain number of times to form the modified and/or delayed optical signal.

It is noted that in this exemplary case, the optical signal is modified and/or delayed in an exclusively optical manner to form the modified and/or delayed optical signal. It is further noted that the optical signal may especially be modified and/or delayed in a repeatable or repeated manner to form the modified and/or delayed optical signal. It might be particularly advantageous if the optical signal is trapped in a loop, especially for the certain number of times, to form the modified and/or delayed optical signal. Accordingly, the tester 30 and/or the optical modification unit 33 may be configured to trap the optical signal in an exclusively optical loop, especially for the certain number of times, to form the modified and/or delayed optical signal. Said exclusively optical loop is exemplarily formed with the aid of the first optically reflective element, exemplarily the first mirror 34a, and the second optically reflective element, exemplarily the second mirror 34b. With respect to said loop or optical loop, respectively, it is noted that the loop or optical loop, respectively, can comprise or be an optical displacement path, a fiber loop, an optical resonator, a free space optical resonator, a multipass cell, a herriott cell, a white cell, or any combination thereof.

It might be particularly advantageous if the first optically reflective element, exemplarily the first mirror 34a, and the second optically reflective element, exemplarily the second mirror 34b, are configured such that the optical signal is reflected between the first optically reflective element, exemplarily the first mirror 34a, and the second optically reflective element, exemplarily the second mirror 34b to achieve the certain number of times.

With respect to the above-mentioned combined optical input-output 32, it is noted that it might be particularly advantageous if the combined optical input-output 32 comprises an optical path selector switch especially for selection between an input path, preferably for inputting the optical signal, an output path, preferably for outputting the modified and/or delayed optical signal, and a modification path, preferably coming from and/or leading to the optical modification unit. Exemplarily, said modification path is connected to the optical switch 36 at one end, and to the (optional) optical amplifier 35 at another end.

With respect to said optical path selector switch, it is noted that it might be particularly advantageous if the optical path selector switch comprises or is an optical polarizing element and/or an optical polarizing beam splitter and/or a chopper wheel, especially an optical chopper wheel, and/or an optical and/or mechanical switch and/or an electro-optical switch and/or a micro-electromechanical system (MEMS).

With respect to the above-mentioned optical switch 36, it is noted that the explanations above regarding the optical switch 26 of FIG. 2 can analogously apply.

Furthermore, with respect to the above-mentioned optical amplifier 35, it is noted that the explanations above regarding the optical amplifier 25 according to FIG. 2 can analogously apply.

Moreover, with respect to the above-mentioned first optical delay line 38 or the second optical delay line 39, respectively, it is noted that the explanations above regarding the first optical delay line 28 or the second optical delay line 29, respectively, according to FIG. 2 can analogously apply. Accordingly, the explanations above regarding the series connection of the first optical delay line 28 and the second optical delay line 29 of FIG. 2 can analogously apply for the series connection of the first optical delay line 38 and the second optical delay line 39 according to FIG. 3.

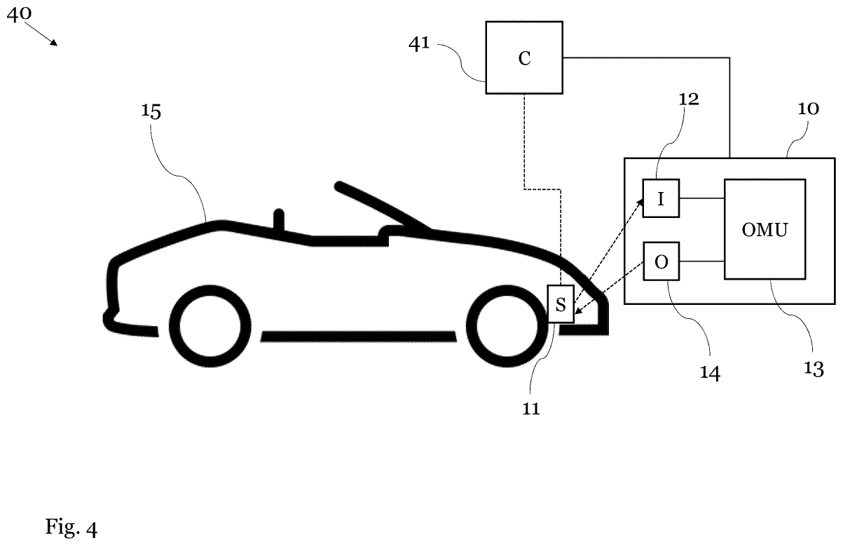

Now, with respect to FIG. 4, an exemplary embodiment of a system 40 for testing an optical sensor is illustrated. Said system 40 exemplarily comprises the tester 10 according to FIG. 1 and a controller 41. Accordingly, all the corresponding explanations above can analogously apply for FIG. 4.

In this context, the controller 41 is configured to control the tester 10 especially in accordance with an optical sensor test scenario. In addition to this or as an alternative, the controller 41 is configured to set the certain number of times especially in accordance with an optical sensor test scenario. With respect to the term “certain number of times”, it is noted that said term may especially be understood as a certain number of loops, which can analogously apply throughout the present disclosure.

It is noted that it might be particularly advantageous if the controller 41 is configured to take into account the corresponding frame rate of the optical sensor 11 especially in the context of controlling the tester 10 and/or setting the certain number of times. Furthermore, the controller 41 may preferably be connectable and/or connected to the optical sensor 11, for instance, for querying said corresponding frame rate and/or for providing control information for the optical sensor 11.

It is further noted that it might be particularly advantageous if the system 40 comprises the optical sensor 11, wherein the optical sensor comprises or is a light detection and ranging, LiDAR, sensor, and/or a light imaging, detection and ranging, LIDAR, sensor and/or a light amplification by stimulated emission of radiation detection and ranging, LADAR, sensor.

As it can further be seen from FIG. 4, the system 40 is exemplarily used in the context of testing an autonomous vehicle, especially an autonomous car, and/or an advanced driver assistance system (ADAS). Accordingly, it might be particularly advantageous if the system 40 comprises or is a test rig for testing an autonomous vehicle, especially an autonomous car, and/or an advanced driver assistance system.

Again, with respect to the controller 41, it is noted that it might be particularly advantageous if the controller 41 is configured to set the certain number of times based on a desired time delay with respect to the optical signal.

It is further noted that it might be particularly advantageous if the tester in the sense of the present disclosure, such as the above-mentioned testers 10, 20, 30, comprises such a controller as the one 41 of FIG. 4.

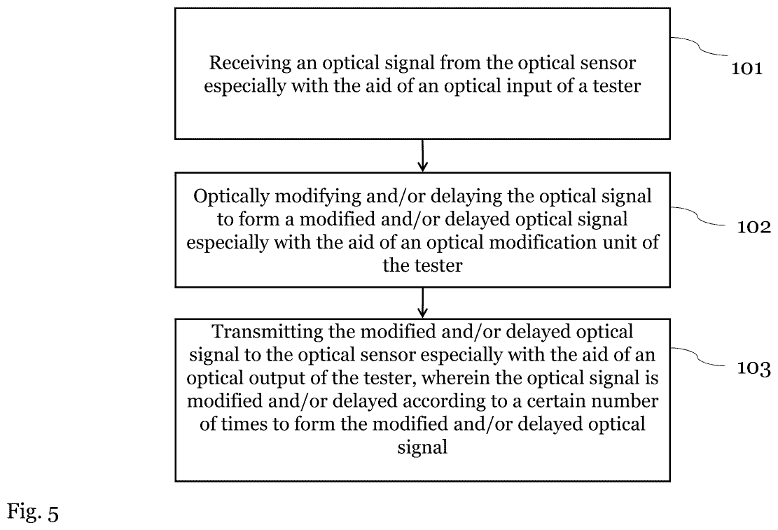

Finally, FIG. 5 illustrates a flow chart of an exemplary embodiment of a method for testing an optical sensor such as the above-mentioned optical sensor 11 of FIG. 1 or FIG. 4, respectively. A first step 101 comprises receiving an optical signal from the optical sensor especially with the aid of an optical input of a tester such as the optical input 12 of the tester 10 of FIG. 1 or FIG. 4, respectively, or the optical input 22 of the tester 20 of FIG. 2 or the combined optical input-output 32, especially the optical input portion thereof, of the tester 30 of FIG. 3. Furthermore, a second step 102 comprises optically modifying and/or delaying the optical signal to form a modified and/or delayed optical signal especially with the aid of an optical modification unit of the tester such as the optical modification unit 13 of the tester 10 of FIG. 1 or FIG. 4, respectively, or the optical modification unit 23 of the tester 20 of FIG. 2 or the optical modification unit 33 of the tester 30 of FIG. 3. Moreover, a third step comprises transmitting the modified and/or delayed optical signal to the optical sensor especially with the aid of an optical output of the tester, such as the optical output 14 of the tester 10 of FIG. 1 or FIG. 4, respectively, or the optical output 24 of the tester 20 of FIG. 2 or the combined optical input-output 32, especially the optical output portion thereof, of the tester 30 of FIG. 3, wherein the optical signal is modified and/or delayed according to a certain number of times to form the modified and/or delayed optical signal.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above-described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A tester for testing an optical sensor, comprising:
an optical input configured to receive an optical signal from the optical sensor,
an optical modification unit configured to optically modify and/or delay the optical signal to form a modified and/or delayed optical signal, and
an optical output configured to transmit the modified and/or delayed optical signal to the optical sensor,
wherein the optical signal is modified and/or delayed according to a certain number of times to form the modified and/or delayed optical signal.

2. The tester according to claim 1,
wherein the optical signal is modified and/or delayed in an exclusively optical manner to form the modified and/or delayed optical signal.

3. The tester according to claim 1,
wherein the optical signal is modified and/or delayed in a repeatable or repeated manner to form the modified and/or delayed optical signal.

4. The tester according to claim 1,
wherein the optical input comprises an optical path selector switch especially for selection between an input path, preferably for inputting the optical signal, and a modification path, preferably coming from and/or leading to the optical modification unit.

5. The tester according to claim 4,
wherein the optical path selector switch comprises or is an optical polarizing element and/or an optical polarizing beam splitter and/or a chopper wheel, especially an optical chopper wheel, and/or an optical and/or mechanical switch and/or an electro-optical switch and/or a micro-electromechanical system.

6. The tester according to claim 1,
wherein the optical output comprises an optical path selector switch especially for selection between an output path, preferably for outputting the modified and/or delayed optical signal, and a modification path, preferably coming from and/or leading to the optical modification unit.

7. The tester according to claim 6,
wherein the optical path selector switch comprises or is an optical polarizing element and/or an optical polarizing beam splitter and/or a chopper wheel, especially and optical chopper wheel, and/or an optical and/or mechanical switch and/or an electro-optical switch and/or a micro-electromechanical system.

8. The tester according to claim 1,
wherein the optical input and the optical output are configured as a combined optical input-output.

9. The tester according to claim 8,
wherein the combined optical input-output comprises an optical path selector switch especially for selection between an input path, preferably for inputting the optical signal, an output path, preferably for outputting the modified and/or delayed optical signal, and a modification path, preferably coming from and/or leading to the optical modification unit.

10. The tester according to claim 9,
wherein the optical path selector switch comprises or is an optical polarizing element and/or an optical polarizing beam splitter and/or a chopper wheel, especially an optical chopper wheel, and/or an optical and/or mechanical switch and/or an electro-optical switch and/or a micro-electromechanical system.

11. The tester according to claim 1, further comprising:
an optical switch,
wherein the optical switch is configured to pass the modified and/or delayed optical signal to the optical output after the optical signal has been modified and/or delayed according to the certain number of times.

12. The tester according to claim 11,
wherein the optical switch comprises or is an electro-optic switch and/or a Pockels cell and/or an acousto-optic modulator, and/or
wherein the tester and/or the optical switch further comprises a polarizer and/or a polarization retarder and/or a half-wave plate and/or a quarter-wave plate and/or an eighth-wave plate, especially wherein the polarizer and/or the polarization retarder and/or the half-wave plate and/or the quarter-wave plate and/or the eighth-wave plate is coupled to and/or part of the optical switch.

13. The tester according to claim 1,
wherein the optical modification unit comprises a circular structure, or
wherein the optical modification unit comprises a linear structure especially comprising at least one optically reflective element, preferably at least two optically reflective elements or two optically reflective elements.

14. The tester according to claim 1,
wherein the optical modification unit comprises:
at least one optical delay line, and/or
at least one switched optical delay line.

15. The tester according to claim 1,
wherein the tester and/or the optical modification unit comprises:
at least one optical amplifier, and/or
at least one optical attenuator.

16. The tester according to claim 1,
wherein the tester and/or the optical modification unit comprises:
an optical modulator configured to add a Doppler shift with respect to the optical signal and/or the modified and/or delayed optical signal.

17. A system for testing an optical sensor, comprising:
a tester according to claim 1, and
a controller,
wherein the controller is configured to control the tester especially in accordance with an optical sensor test scenario, and/or
wherein the controller is configured to set the certain number of times especially in accordance with an optical sensor test scenario.

18. The system according to claim 17,
wherein the controller is configured to take into account the corresponding frame rate of the optical sensor especially in the context of controlling the tester and/or setting the certain number of times.

19. The system according to claim 17, further comprising:
the optical sensor,
wherein the optical sensor comprises or is a light detection and ranging, LiDAR, sensor, and/or a light imaging, detection and ranging, LIDAR, sensor and/or a light amplification by stimulated emission of radiation detection and ranging, LADAR, sensor.

20. A method for testing an optical sensor, comprising the steps of:
receiving an optical signal from the optical sensor especially with the aid of an optical input of a tester,
optically modifying and/or delaying the optical signal to form a modified and/or delayed optical signal especially with the aid of an optical modification unit of the tester, and
transmitting the modified and/or delayed optical signal to the optical sensor especially with the aid of an optical output of the tester,
wherein the optical signal is modified and/or delayed according to a certain number of times to form the modified and/or delayed optical signal.
